(19) United States
(12) Patent Application Publication
(10) Pub. No.: US 2017/0129720 A1
(43) Pub. Date: May 11, 2017

(54) TELESCOPING LOADING DOCK BUMPER

(71) Applicant: Andrew Flinn, Oneida, NY (US)

(72) Inventor: Andrew Flinn, Oneida, NY (US)

(21) Appl. No.: 14/934,704

(22) Filed: Nov. 6, 2015

(51) Int. Cl. B65G 69/00

(52) U.S. Cl. CPC B65G 69/001

(57) ABSTRACT

An improving loading dock bumper system having a pair of telescoping bumpers positioned on either side of the loading dock. The bumpers may be extended longitudinally to contact a vehicle having an abnormally shaped rear end further from the loading dock to prevent vehicular damage or damage the loading dock.

### BACKGROUND OF THE INVENTION

1. Field of the Invention

The present invention relates to docket bumpers and, more specifically, a telescoping dock bumper for protecting against damage to loading docks and the accompanying building structure.

2. Description of the Related Art

A typical loading dock of a building includes an opening having an elevated platform for loading and unloading vehicles. Some loading docks include a dock leveler having a moveable deck with a front edge and lip that can be raised or lowered to adjust for different height vehicle beds. Dock bumpers are positioned on either side of the opening to protect the wall of the building and the dock leveler as well as the back of the vehicle from damage that may occur from vehicle impact. As dock bumpers are either fixed to the walls of the building or movable upward or downward with the dock leveler, the bumpers will fail to protect against damage that can occur when a vehicle having an abnormal rear end or protrusion is backed up to and into the dock. Accordingly, there is a need in the art for a bumper system that can adjust to differently shaped vehicle to protect against damage regardless of the shape of the rear end of the particular vehicle.

### BRIEF SUMMARY OF THE INVENTION

The present invention is an improved loading dock bumper system comprising a pair of telescoping bumpers positioned on either side of a loading dock. Each bumper has at least a first unit having a face extending along a plane that is dimensioned to telescope within at least a second unit for movement between a retracted position and an extended position. An actuator is coupled to the first unit for moving the bumper between the retracted position and the extended position. The first unit telescopes with the second unit, and any additional units, along an axis that is perpendicular to the plane of the face of the first unit so that the telescoping bumper can be extended or retracted from the face of loading dock, thereby altering the distance that a vehicle may be brought into proximity with the loading dock. Preferably, the actuator is hydraulic and is controlled by a user interface that allows a dock operator to extend and retract the telescoping bumpers as needed using either an automated distance control or manual adjustment.

### BRIEF DESCRIPTION OF THE SEVERAL VIEWS OF THE DRAWING(S)

The present invention will be more fully understood and appreciated by reading the following Detailed Description in conjunction with the accompanying drawings, in which:

FIG. 1 is a perspective view of a loading dock having a telescoping loading dock bumper according to the present invention;

FIG. 2 is front view of a loading dock having a telescoping loading dock bumper according to the present invention;

FIG. 3 is a perspective view of a telescoping loading dock bumper for a loading dock according to the present invention;

FIG. 4 is a partial cut-away view of a telescoping loading dock bumper for a loading dock according to the present invention

FIG. 5 is a top view of a loading dock having a telescoping loading dock bumper in a retracted position according to the present invention;

FIG. 6 is a top view of a loading dock having a telescoping loading dock bumper in an extended position according to the present invention;

FIG. 7 is a flowchart of a control process for a telescoping loading dock bumper according to the present invention.

### DETAILED DESCRIPTION OF THE INVENTION

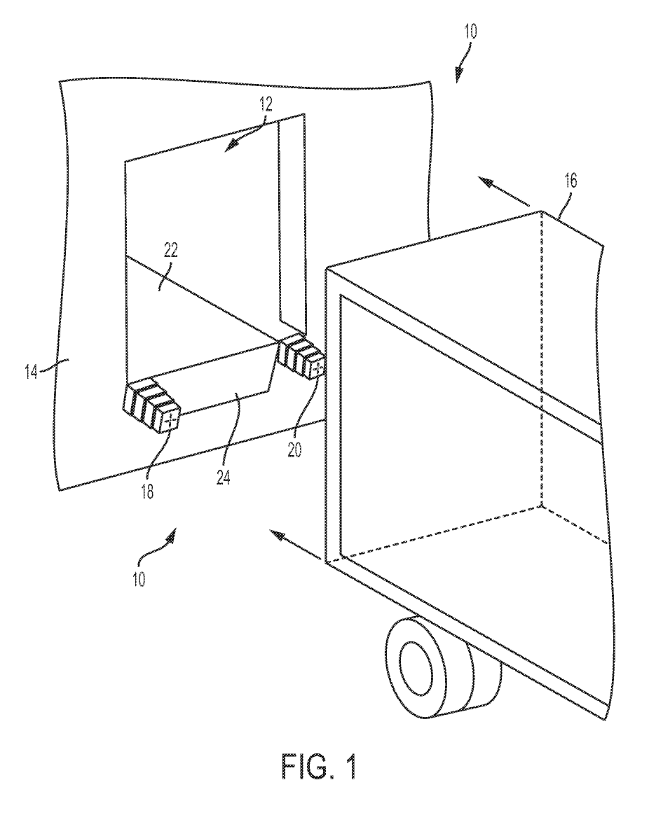

Referring now to the drawings, wherein like reference numerals refer to like parts throughout, there is seen in FIG. 1 a telescoping bumper system 10 for a loading dock 12 in the side of a building 14. As a vehicle 16 is backed into position for unloading, a pair of telescoping bumpers 18 and 20 may be extended or retracted to provide appropriate spacing between the rear of vehicle 16 and the building 14 so that no damage occurs to loading dock 12 or vehicle 16, such as when a vehicle having an irregularly shaped or sized rear end is backed into position in front of loading dock 12.

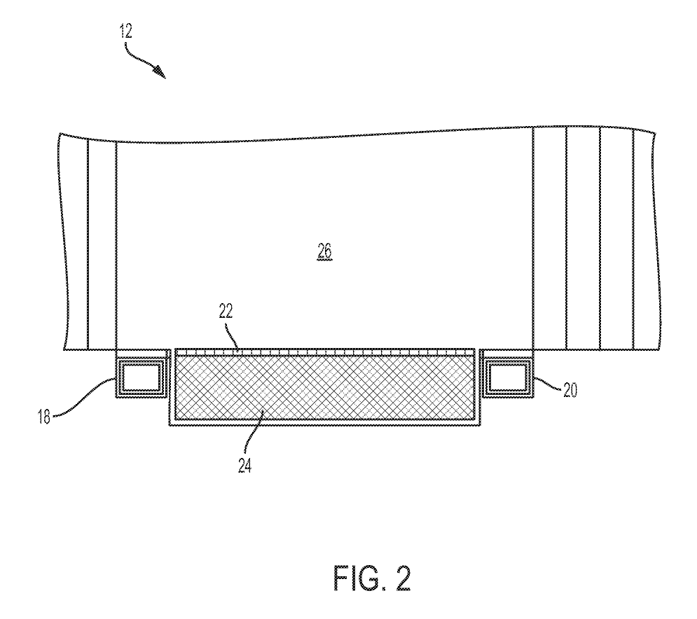

Referring to FIG. 2, system 10 includes telescoping bumpers 18 and 20 positioned on either side of loading dock 12, which may include a dock leveler 22 with a lip 24 for extending into the rear of vehicle 16. Telescoping bumpers 18 and 20 preferably provide an impact surface that is about 10 to 36 inches in height and 10 to 24 inches in width and can extend up to 36 inches from the face of loading dock 12 to provide a sufficient set off distance between loading dock 12 and the rearward most point of vehicle 16 to prevent damage while still allowing for dock leveler 22 and lip 24 to be coupled to vehicle 16 for loading and unloading operations.

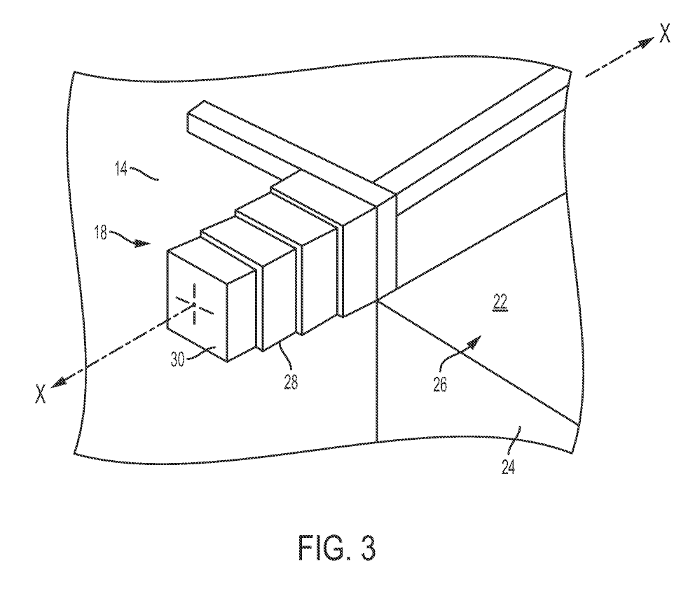

Referring to FIG. 3, each telescoping bumper 18 and 20 is mounted to one side of the central cavity 26 of loading dock 12 that houses dock leveler 22. Each telescoping bumper 18 and 20 comprises a series of nested units 28, each of which is dimensioned to either accept or be accepted within an adjacent unit 28 so that bumper 18 or 20 can be extended or retracted as units 28 telescope relative to each other. The foremost unit 28 has a face 30 extending along a plane that is vertical (or co-planar with the front of loading dock 12 and/or building wall 14) and has a surface adapted for cushioning against a vehicular impact, such as by being formed of a polymeric material and/or including a protective metal faceplate as is known in the art. Although units 28 are depicted in FIG. 3 as being generally cubical, units 28 may be formed in any shape that allows telescoping bumper 18 or 20 to extend and retract while providing structural support to telescoping bumper 18 or 20 and enclosing the inside or telescoping bumper 18 and 20 against the environment. As seen in FIG. 3, the telescoping of bumper 18 or 20 along longitudinal axis X-X is perpendicular to the plane of face 30 of front unit 28 so that telescoping bumper 18 or 20 extends perpendicularly outwardly from the front of loading dock 12 and/or building wall 14.

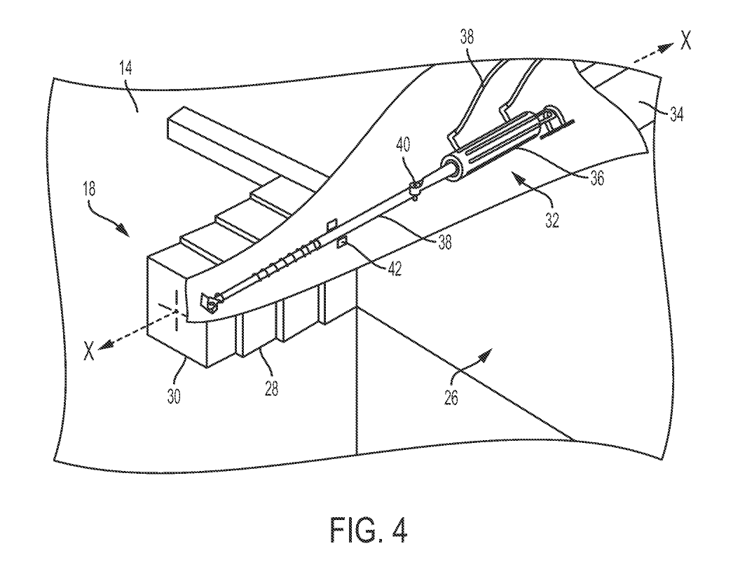

Referring to FIG. 4, each telescoping bumper 18 or 20 is driven by an actuator 32 positioned proximately in loading dock 12, such as within the side walls 34 defining cavity 26 for dock leveler 22. Actuator 32 may be enclosed within a housing that is mounted in loading dock 12 when loading dock 12 is built, or actuator 32 may be retrofit into an existing loading dock, such as by excavating sufficient material from either side of loading dock to allow actuator to be positioned therein. Preferably, actuator 32 is positioned in a sealed housing, whether embedded in the material forming loading dock 12 or not, so as to protect against environmental contamination. In one embodiment, actuator 32 may comprise a hydraulic cylinder 36 operated via hydraulic lines 38 that extend to a remotely positioned hydraulic system, such as the hydraulic system that is already on site and used to operate dock leveler 22. Hydraulic cylinder 36 includes a two-stage actuating ram 38 having a dampening spring 40, or comparable shock absorbing structure, positioned between the stages to absorb energy from vehicular impacts onto bumper 18 or 20 and to prevent any resulting damage to actuator 32. Actuating ram 38 is coupled to foremost unit 28 of telescoping bumper 18 or 20 so that hydraulic cylinder 36 may be operated to extend or retract telescoping bumper 18 or 20 away from or toward loading dock 12 to accommodate the specific requirements of a particle vehicle 16 to be loaded or unloaded. The connections between ram 38 and foremost unit 18, as well as between ram 38 and hydraulic cylinder 36 may include a pin 40 for easy assembly, disassembly, and replacement of worn parts. One or more sensors 42 may also be coupled to inside of telescoping bumper 28 and/or actuator 32 to confirm the position of telescoping bumper 18 or 20, to detect when vehicle 16 has impacted telescoping bumper 18 or 20, or to provide feedback on the operation of telescoping bumper 18 or 20. Actuator 32 may comprise other mechanisms for imparting the requisite longitudinal movement to control telescoping bumper 18 or 20, such as an electric actuators, pneumatic actuators, and mechanical actuators.

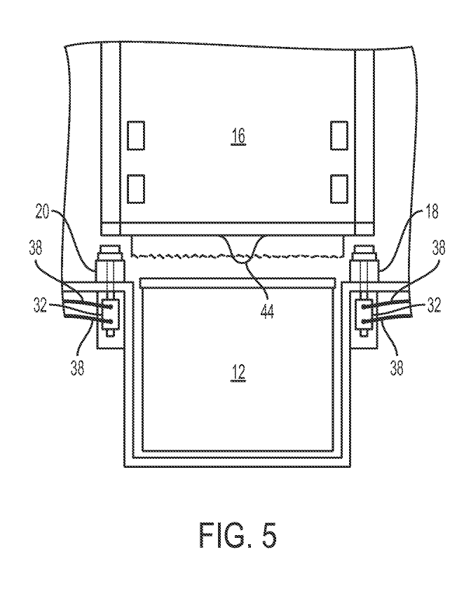

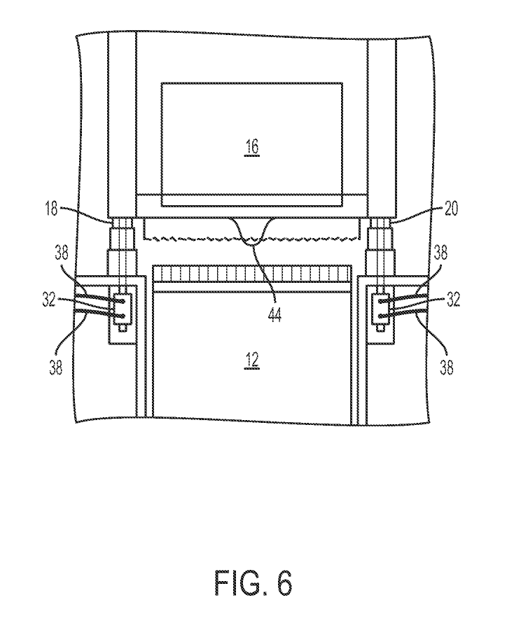

As seen in FIG. 5, when vehicle 16 having an abnormally elongated rear end 44, such as when vehicle is outfitted with a conveyor, is backed toward locking dock 12, telescoping bumpers 18 and 20 may be extended to maintain a safe distance between the elongated rear end 44 and locking dock 12, as seen in FIG. 6, thereby preventing damage to loading dock 12 or rear end 44 of vehicle 16.

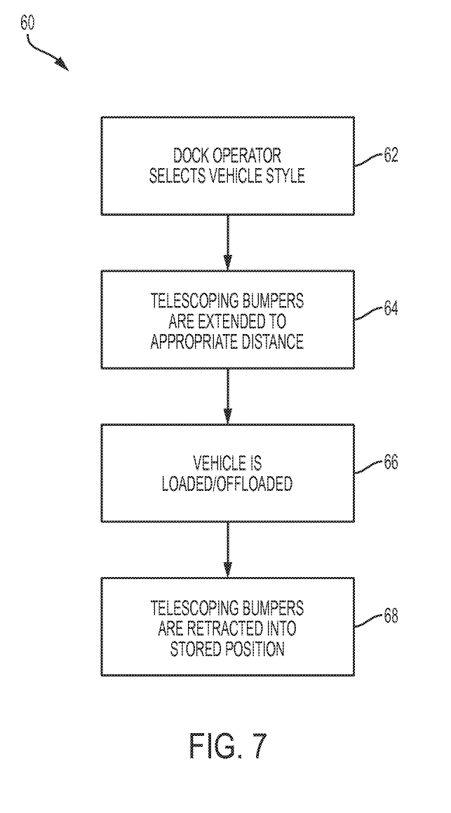

Referring to FIG. 7, a control process 60 for operating telescoping bumpers 18 and 20 may comprise a dock operator selecting a particular vehicle style 62, such as from a menu displayed by a user interface of a control panel that matches an approaching vehicle. Next, actuator 32 operators telescoping bumpers 18 and 20 so that they extend a predetermined distance 64 from loading dock 12 so that the particular vehicle will contact telescoping bumpers 18 and 20 before any portion of the particular vehicle impacts the other structures of loading dock 12. Finally, after vehicle 16 has been loaded or off-loaded 66, telescoping bumpers 18 and 20 may be retracted into a stored positioned 68 to prevent any inadvertent damage that may occur to telescoping bumpers 18 and 20 if they are left in the extended position.

What is claimed is:

1. An improved loading dock bumper system, comprising:
a bumper having at least a first unit having a face extending along a plane that is dimensioned to telescope within at least a second unit for movement between a retracted position and an extended position; and
an actuator coupled to the first unit for moving the bumper between the retracted position and the extended position.

2. The system of claim 1, wherein the first unit telescopes with the second unit along an axis that is perpendicular to the plane of the face of the first unit.

3. The system of claim 2, wherein the actuator is hydraulic.

4. The system of claim 3, wherein the bumper is positioned proximately to a loading dock.

5. The system of claim 4, wherein the bumper extends and retracts along an axis that is perpendicular to the face of the bumper.

6. The system of claim 5, wherein the face of the bumper is vertical.

7. The system of claim 6, wherein the actuator includes a bias member for absorbing any impact onto the face of bumper.

8. The system of 7, wherein the face of the bumper is rectangular.

9. A method of protecting a loading dock, comprising the steps of:
positioning at least one bumper having at least a first unit having a face extending along a plane that is dimensioned to telescope within at least a second unit for movement between a retracted position and an extended position; and
extending the bumper using an actuator until the bumper is a predetermined distance from the loading dock prior to a vehicle being positioned at the loading dock.

10. The method of claim 9, wherein the first unit telescopes with the second unit along an axis that is perpendicular to the plane of the face of the first unit.

11. The method of claim 10, wherein the actuator is hydraulic.

12. The method of claim 11, wherein the bumper is positioned proximately to a loading dock.

13. The method of claim 12, wherein the bumper extends and retracts along an axis that is perpendicular to the face of the bumper.

14. The method of claim 13, wherein the face of the bumper is vertical.

15. The method of claim 14, wherein the actuator includes a bias member for absorbing any impact onto the face of bumper.

16. The method of 15, wherein the face of the bumper is rectangular.

17. The method of claim 16, further comprising the step of retracting the bumper after the vehicle has departed from the loading dock.
